(19) United States
(12) Patent Application Publication
(10) Pub. No.: US 2013/0072250 A1
(43) Pub. Date: Mar. 21, 2013

(54) OUTAGE BASED OUTER LOOP POWER CONTROL FOR WIRELESS COMMUNICATIONS SYSTEMS

(71) Applicants: Wei Zhang, San Diego, CA (US); Jittra Jootar, San Diego, CA (US); Kunal Srivastava, San Diego, CA (US); Guang Xie, San Diego, CA (US); Feng Lu, Sunnyvale, CA (US); Jonathan Sidi, San Diego, CA (US)

(72) Inventors: Wei Zhang, San Diego, CA (US); Jittra Jootar, San Diego, CA (US); Kunal Srivastava, San Diego, CA (US); Guang Xie, San Diego, CA (US); Feng Lu, Sunnyvale, CA (US); Jonathan Sidi, San Diego, CA (US)

(73) Assignee: QUALCOMM Incorporated, San Diego, CA (US)

(21) Appl. No.: 13/424,665

(22) Filed: Mar. 20, 2012

Related U.S. Application Data
(60) Provisional application No. 61/469,519, filed on Mar. 30, 2011.

(51) Int. Cl. H04W 52/08; H04W 52/12; H04W 52/24

(52) U.S. Cl. 455/522

(57) ABSTRACT

A slot in a frame of n frames is received at user equipment (UE). Valid slots are detected based on a given validity criterion. The valid slots are classified as outage slots if an estimated signal quality does not exceed an outage signal quality. A total valid slot count and a total outage slot count are accumulated over an outer loop duration spanning a plurality of the slots. The total outage slot count is compared to a preset ratio of the total valid slot count. A target signal quality is updated based on the comparison.

### CLAIM OF PRIORITY UNDER 35 U.S.C. §119

The present Application for Patent claims priority to Provisional Application No. 61/469,519 “OUTAGE BASED OUTER LOOP POWER CONTROL FOR WIRELESS COMMUNICATIONS SYSTEMS,” filed Mar. 30, 2011, and assigned to the assignee hereof and hereby expressly incorporated by reference herein.

### FIELD

The present application pertains to power control for wireless communications systems, in particular to inner loop and outer loop power control for a Fractional Dedicated Physical Channel (FDPCH)

### BACKGROUND

Cellular wireless communications systems generally comprise a number of radio transceivers, or base stations, that define service areas or cells. Cellular systems are designed specifically to accommodate a number of users of user equipment (UE) as the user moves around within the system. Thus, various UEs may interact with various base stations as users move through the system. As the user moves throughout the system, power control may be used by the base station and/or the UE to ensure sufficient quality of service of signals received at the base station and/or the UE. Spread spectrum systems such as Code Division Multiple Access (CDMA) typically employ open loop and/or closed loop power control schemes. Closed loop power control includes cooperation between the transmitter, which can be either of the UE and the base station, and the receiver, which can be the other of the UE and the base station.

Closed loop power control can include an “inner loop” power control and an “outer loop” power control. Inner loop power control generally includes the receiver comparing a quality of the signal quality it receives from the transmitter against a threshold quality and, based on the comparison, sending a power adjustment signal to the transmitter. Outer loop power control generally includes the transmitter signal being encoded such that a quality of the decoding at the receiver is indicative of an error rate. The receiver calculates or measures the decoding quality, generally over a time interval significantly longer than the time interval used for quality measurement in an inner loop power control. The receiver, based on the decoding quality calculated or measured over the longer interval, adjusts the threshold it uses for the inner loop power control.

As one example of an inner loop power control, a UE can estimate a signal to interference ratio (SIRE) of a downlink signal received from the base station and compare the estimated quality to a target downlink signal quality, for example an estimated signal to interference ratio (SIRT). The SIRE is obtained is obtained on per-slot basis. Based on the comparison the UE can generate, and send to the base station a downlink transmit power control (TPC) signal, for example, an up/down adjustment command.

One example outer loop power control, which can be combined with the above example UE inner loop control of the base station transmit power, is the UE monitoring a frame decoding error rate and, at given intervals, comparing the frame decoding error rate to a threshold. If the frame decoding error rate at the UE is above a threshold, the UE can increase the SIRT it uses in its inner loop power control of the base station transmitter power. If the frame decoding error rate at the US is lower than the threshold, the UE can decrease the SIRT it uses for the inner loop power control.

Performing this conventional outer loop power control of the SIRT used for the inner loop power control requires the transmitted signal have a coding that, when decoded, provides block error rate information.

Among other features and benefits of the disclosed embodiments is an outer loop control of the inner loop short interval quality threshold, for closed loop control of signals without an error indicating coding.

### SUMMARY

The described features generally relate to one or more improved systems, methods and/or apparatuses for power control for wireless communications systems. Further scope of the applicability of the described methods and apparatuses will become apparent from the following detailed description, claims, and drawings.

Accordingly, an embodiment can include a method for closed loop power control of a signal having slots. The method can include detecting valid slots based on a given validity criterion; classifying the valid slots outage slots if an estimated signal quality does not exceed an outage signal quality; accumulating, over an outer loop duration spanning a plurality of the slots, a total valid slot count and a total outage slot count; comparing the total outage slot count to a preset ratio of the total valid slot count; and updating a target signal quality based on the comparison.

Another embodiment can include user equipment (UE) configured to perform closed loop power control of a signal having slots. The UE can include logic configured to detect valid slots based on a given validity criterion; logic configured to classify the valid slots as outage slots if an estimated signal quality does not exceed an outage signal quality; logic configured to accumulate, over an outer loop duration spanning a plurality of the slots, a total valid slot count and a total outage slot count; logic configured to compare the total outage slot count to a preset ratio of the total valid slot count; and logic configured to update a target signal quality based on the comparison.

Another embodiment can include an apparatus for closed loop power control of a signal having slots. The apparatus can include means for detecting valid slots based on a given validity criterion; means for classifying the valid slots as outage slots if an estimated signal quality does not exceed an outage signal quality; means for accumulating, over an outer loop duration spanning a plurality of the slots, a total valid slot count and a total outage slot count; means for comparing the total outage slot count to a preset ratio of the total valid slot count; and means for updating a target signal quality based on the comparison.

Another embodiment can include a non-transitory computer-readable storage medium containing instructions stored thereon, which, when executed by at least one processor causes the at least one processor to perform power control. The instructions can include at least one instruction to detect valid slots based on a given validity criterion; at least one instruction to classify valid slots as outage slots if an estimated signal quality does not exceed an outage signal quality; at least one instruction to accumulate, over an outer loop duration spanning a plurality of the slots, a total valid slot count and a total outage slot count; at least one instruction to compare the total outage slot count to a preset ratio of the total valid slot count; and at least one instruction to update a target signal quality based on the comparison.

### BRIEF DESCRIPTION OF THE DRAWINGS

The features, objects, and advantages of the disclosed methods and apparatus will become more apparent from the detailed description set forth below when taken in conjunction with the drawings in which like reference characters identify correspondingly throughout.

FIG. 1 is a block diagram of a radio access system having two radio network subsystems along with its interfaces to the core and the user equipment.

FIG. 2 is a simplified representation of a cellular communications system.

FIG. 3 is detailed herein below, wherein specifically, a Node B and radio network controller interface with a packet network interface; is a portion of a communication system, including a radio network controller and a Node B.

FIG. 4 is a block diagram of user equipment (UE).

FIG. 5 is a functional block flow diagram of signals through structures of a transmitter.

FIG. 6 is a flowchart illustrating a method of power control for wireless communications systems.

FIG. 7 illustrates a flowchart of a method for closed loop power control.

FIG. 8 illustrates elements of a UE having closed loop power control.

### DETAILED DESCRIPTION

Various aspects are now described with reference to the appended drawings. In the following description, for purposes of explanation, numerous specific details are set forth to provide a thorough understanding of the various concepts in accordance with the exemplary embodiments. In some instances, well-known structures and devices are shown in block diagram form to avoid obscuring the novel concepts of the described methods and apparatuses. The examples are only for purposes of illustrating concept, and will to be understood and appreciated that practices in accordance with the various exemplary embodiments may include additional devices, components, and/or modules, and/or may not include all of the devices, components, and/or modules discussed in connection with the figures.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

As used herein, the terms “component,” “module,” “system” and the like are intended to include a computer-related entity, such as but not limited to hardware, firmware, a combination of hardware and software, software, or software in execution. For example, a component may be, but is not limited to being, a processor, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal X.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, as used in this specification, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various exemplary embodiments and aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

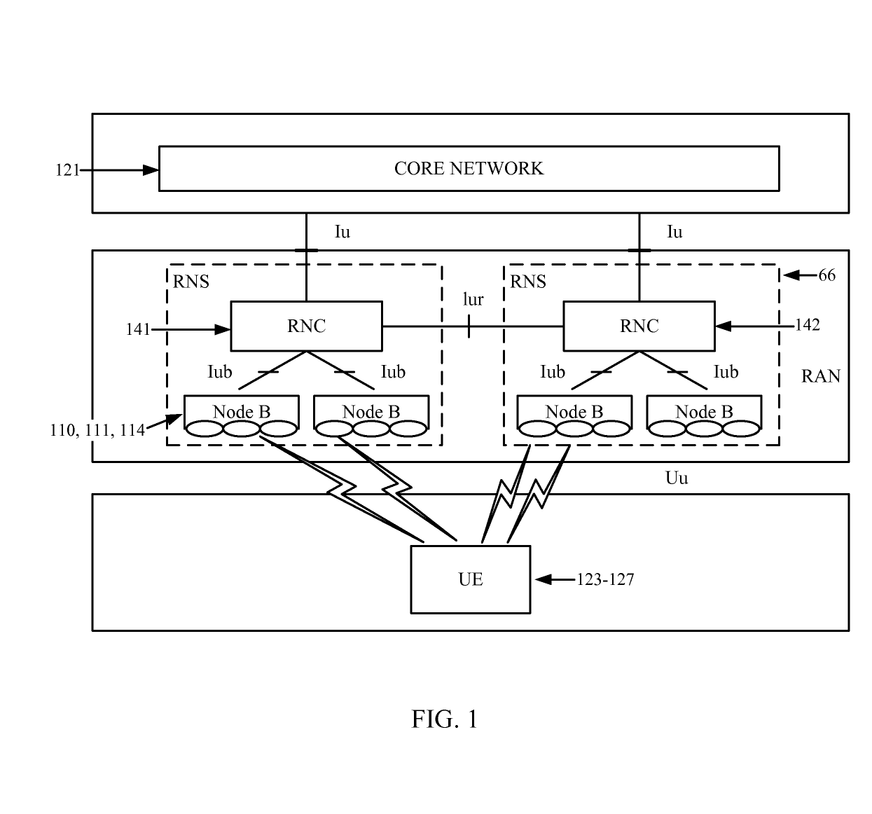

Further described herein with reference to FIGS. 1-4 is an example of a radio network in which the principles of the disclosure may be applied. Node Bs 110, 111, 114 and radio network controllers 141-144 are parts of a network called a “radio network,” “RN,” “access network (AN).” The wireless communication between the UE 123-127 and the Node Bs 110, 111, 114 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), 3GPP Long Term Evolution (LTE) or other protocols that may be used in a wireless communications network or a data communications network. Accordingly, the illustrations provided herein are not intended to limit the embodiments of the invention and are merely to aid in the description of aspects of embodiments of the invention.

The radio network may be a UMTS Terrestrial Radio Access Network (UTRAN). A UMTS Terrestrial Radio Access Network (UTRAN) is a collective term for the Node Bs (or base stations) and the control equipment for the Node Bs (or radio network controllers (RNC)) it contains which make up the UMTS radio access network. This is a 3G communications network which can carry both real-time circuit switched and IP-based packet-switched traffic types. The UTRAN provides an air interface access method for the user equipment (UE) 123-127. Connectivity is provided between the UE and the core network by the UTRAN. The radio network may transport data packets between multiple user equipment (e.g. UEs 123-127).

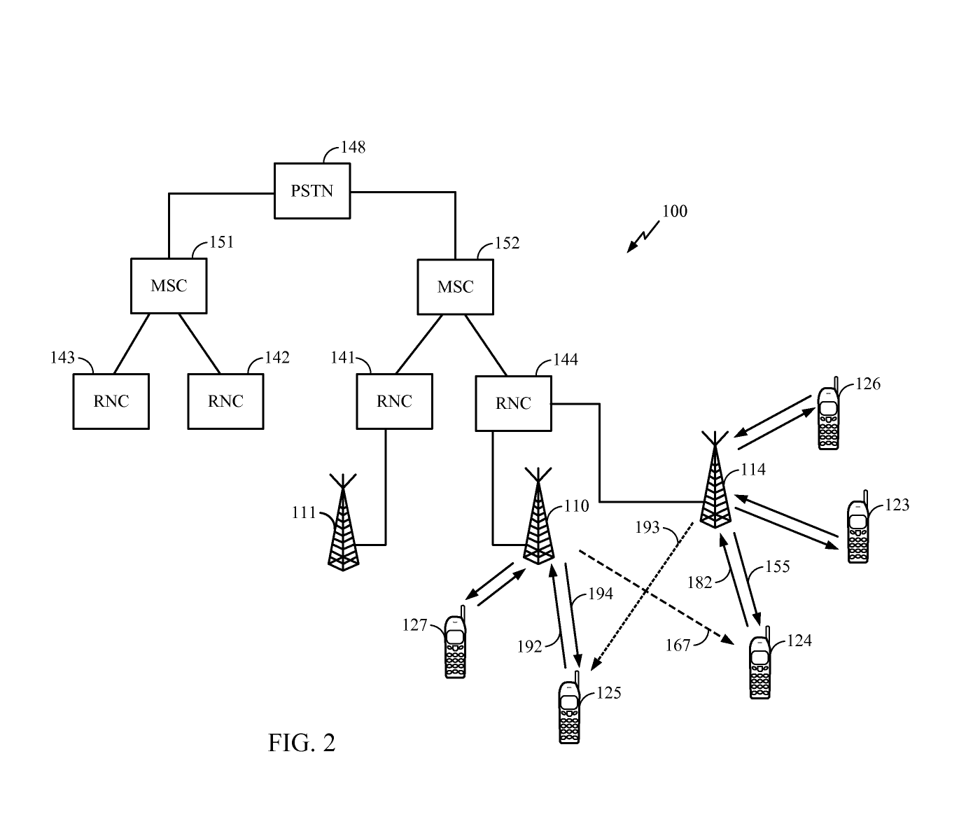

The UTRAN is connected internally or externally to other functional entities by four interfaces: Iu, Uu, Iub and Iur. The UTRAN is attached to a GSM core network 121 via an external interface called Iu. Radio network controller (RNC) 141-144 (shown in FIG. 2), of which 141, 142 are shown in FIG. 1, supports this interface. In addition, the RNCs 141-144 manage a set of base stations called Node Bs through interfaces labeled Iub. The Iur interface connects the two RNCs 141-142 with each other. The UTRAN is largely autonomous from the core network 121 since the RNCs 141-144 are interconnected by the Iur interface. FIG. 1 discloses a communication system which uses the RNC, the Node Bs and the Iu and Uu interfaces. The Uu is also external and connects the Node Bs 110, 111, 114 with the UE 123-127, while the Iub is an internal interface connecting the RNC 142-144 with the Node Bs 110, 111, 114.

The radio network may be further connected to additional networks outside the radio network, such as a corporate intranet, the Internet, or a conventional public switched telephone network as stated above, and may transport data packets between each user equipment device 123-127 and such outside networks.

FIG. 2 illustrates selected components of a communication network 100, which includes radio network controller (RNC) (or base station controllers (BSC)) 141-144 coupled to Node Bs (or base stations or wireless base transceiver stations) 110, 111, and 114. The Node Bs 110, 111, 114 communicate with user equipment (or remote stations) 123-127 through corresponding wireless connections 155, 167, 182, 192, 193, 194. A communications channel includes a forward link (FL) (also known as a downlink) for transmissions from the Node Bs 110, 111, 114 to the user equipment (UE) 123-127, and a reverse link (RL) (also known as an uplink) for transmissions from the UE 123-127 to the Node Bs 110, 111, 114. The RNCs 141-144 provides control functionalities for one or more Node Bs. The radio network controllers 141-144 are coupled to a public switched telephone network (PSTN) 148 through mobile switching centers (MSC) 151, 152. In another example, the radio network controllers 141-144 are coupled to a packet switched network (PSN) (not shown) through a packet data server node (PDSN) (not shown). Data interchange between various network elements, such as the radio network controllers 141-144 and a packet data server node, can be implemented using any number of protocols, for example, the Internet Protocol (IP), an asynchronous transfer mode (ATM) protocol, T1, E1, frame relay, or other protocols.

Each RNC fills multiple roles. First, it may control the admission of new mobiles or services attempting to use the Node B. Second, from the Node B, or base station, point of view, the RNC is a controlling RNC. Controlling admission ensures that mobiles are allocated radio resources (bandwidth and signal/noise ratio) up to what the network has available. The RNC is where the Node B's Iub interface terminates. From the UE, or mobile, point of view, the RNC acts as a serving RNC in which it terminates the mobile's link layer communications. From a core network point of view, the serving RNC terminates the Iu for the UE. The serving RNC also controls the admission of new mobiles or services attempting to use the core network over its Iu interface.

For an air interface, UMTS most commonly uses a wideband spread-spectrum mobile air interface known as wideband code division multiple access (or W-CDMA). W-CDMA uses a direct sequence code division multiple access signaling method (or CDMA) to separate users. W-CDMA (Wideband Code Division Multiple Access) is a third generation standard for mobile communications. W-CDMA evolved from GSM (Global System for Mobile Communications)/GPRS a second generation standard, which is oriented to voice communications with limited data capability. The first commercial deployments of W-CDMA are based on a version of the standards called W-CDMA Release 99.

The Release 99 specification defines two techniques to enable uplink packet data. Most commonly, data transmission is supported using either the Dedicated Channel (DCH) or the Random Access Channel (RACH). However, the DCH is the primary channel for support of packet data services. Each remote station 123-127 uses an orthogonal variable spreading factor (OVSF) code. An OVSF code is an orthogonal code that facilitates uniquely identifying individual communication channels. In addition, micro diversity is supported using soft handover and closed loop power control is employed with the DCH.

Pseudorandom noise (PN) sequences are commonly used in CDMA systems for spreading transmitted data, including transmitted pilot signals. The time required to transmit a single value of the PN sequence is known as a chip, and the rate at which the chips vary is known as the chip rate. Inherent in the design of direct sequence CDMA systems is a receiver that aligns its PN sequences to those of the Node Bs 110, 111, 114. Some systems, such as those defined by the W-CDMA standard, differentiate base stations 110, 111, 114 using a unique PN code for each, known as a primary scrambling code. The W-CDMA standard defines two Gold code sequences for scrambling the downlink, one for the in-phase component (I) and another for the quadrature (Q). The I and Q PN sequences together are broadcast throughout the cell without data modulation. This broadcast is referred to as the common pilot channel (CPICH). The PN sequences generated are truncated to a length of 38,400 chips. The period of 38,400 chips is referred to as a radio frame. Each radio frame is divided into 15 equal sections referred to as slots. W-CDMA Node Bs 110, 111, 114 operate asynchronously in relation to each other, so knowledge of the frame timing of one base station 110, 111, 114 does not translate into knowledge of the frame timing of any other Node Bs 110, 111, 114. In order to acquire this knowledge, W-CDMA systems uses synchronization channels and a cell searching technique.

3GPP Release 5 and later supports High-Speed Downlink Packet Access (HSDPA). 3GPP Release 6 and later supports High-Speed Uplink Packet Access (HSUPA) HSDPA and HSUPA are sets of channels and procedures that enable high-speed packet data transmission on the downlink and uplink, respectively. Release 7 HSPA+ uses three enhancements to improve data rate. First, it introduced support for 2×2 MIMO on the downlink. With MIMO, the peak data rate supported on the downlink is 28 Mbps. Second, higher order modulation is introduced on the downlink. The use of 64 QAM on the downlink allows peak data rates of 21 Mbps. Third, higher order modulation is introduced on the uplink. The use of 16 QAM on the uplink allows peak data rates of 11 Mbps.

In HSUPA, the Node Bs 110, 111, 114 allows several user equipment devices 123-127 to transmit at a certain power level at the same time. These grants are assigned to users by using a fast scheduling algorithm that allocates the resources on a short-term basis (every tens of ms). The rapid scheduling of HSUPA is well suited to the bursty nature of packet data. During periods of high activity, a user may get a larger percentage of the available resources, while getting little or no bandwidth during periods of low activity.

In 3GPP Release 5, for example, HSDPA, base transceiver stations 110, 111, 114 of an access network sends downlink payload data to user equipment devices 123-127 on High Speed Downlink Shared Channel (HS-DSCH), and the control information associated with the downlink data on High Speed Shared Control Channel (HS-SCCH). There are 256 Orthogonal Variable Spreading Factor (OVSF or Walsh) codes used for data transmission. In HSDPA systems, these codes are partitioned into release 1999 (legacy system) codes that are typically used for cellular telephony (voice), and HSDPA codes that are used for data services. For each transmission time interval (TTI), the dedicated control information sent to an HSDPA-enabled user equipment device 123-127 indicates to the device which codes within the code space will be used to send downlink payload data to the device, and the modulation that will be used for transmission of the downlink payload data.

With HSDPA operation, downlink transmissions to the user equipment devices 123-127 may be scheduled for different transmission time intervals using the 15 available HSDPA OVSF codes. For a given TTI, each user equipment device 123-127 may be using one or more of the 15 HSDPA codes, depending on the downlink bandwidth allocated to the device during the TTI.

In a MIMO system, there are N (# of transmitter antennas) by M (# of receiver antennas) signal paths from the transmit and the receive antennas, and the signals on these paths are not identical. MIMO creates multiple data transmission pipes. The pipes are orthogonal in the space-time domain. The number of pipes equals the rank of the system. Since these pipes are orthogonal in the space-time domain, they create little interference with each other. The data pipes are realized with proper digital signal processing by properly combining signals on the N×M paths. It is noted that a transmission pipe does not correspond to an antenna transmission chain or any one particular transmission path.

Uplink transmit diversity (ULTD) schemes employ more than one transmit antenna (usually two) at the UE to improve the uplink transmission performance, e.g., reduce the user equipment (UE) transmit power, or increase the UE coverage range, or increase the UE data rate, or the combination of the above It can also help improve the overall system capacity. Based on the feedback requirements, ULTD schemes can be categorized into closed-loop (CL) and open-loop (OL) schemes. From the transmitter perspective, ULTD schemes can be classified as beamforming (BF) and antenna switching (AS) schemes.

In general, in closed-loop (CL) transmit diversity (TD) schemes the receiver provides explicit feedback information about the spatial channel to assist the transmitter in choosing a transmission format over multiple transmit antennas. On the other hand, openloop (OL) TD schemes do not. In the context of the WCDMA uplink, the term OL TD schemes includes the schemes without core standards change, i.e., without introducing new feedback channels. There are two categories of CLTD schemes. In the CLTD beamforming scheme, the Node B feeds back to the UE a precoding (or beamforming) vector to be used over multiple transmit antennas so that the signals received at the Node B are constructively added. This in turn maximizes the receiver signal to noise ratio (SNR) and achieves the beamforming effect. In the CLTD antenna switching scheme, the Node B feeds back to the UE its choice on which transmit antenna the UE should use. This choice results in the largest channel gain between the UE transmit antenna and the Node B receive antennas. Between the two schemes, CLTD BF can achieve a better tradeoff between how fast to track the channel vs. how often the scheme may disrupt the channel phase.

Communication systems may use a single carrier frequency or multiple carrier frequencies. Each link may incorporate a different number of carrier frequencies. Furthermore, an access terminal 123-127 may be any data device that communicates through a wireless channel or through a wired channel, for example using fiber optic or coaxial cables. An access terminal 123-127 may be any of a number of types of devices including but not limited to PC card, compact flash, external or internal modem, or wireless or wireline phone. The access terminal 123-127 is also known as user equipment (UE), a remote station, a mobile station or a subscriber station. Also, the UE 123-127 may be mobile or stationary.

User equipment 123-127 that has established an active traffic channel connection with one or more Node Bs 110, 111, 114 is called active user equipment 123-127, and is said to be in a traffic state. User equipment 123-127 that is in the process of establishing an active traffic channel connection with one or more Node Bs 110, 111, 114 is said to be in a connection setup state. The communication link through which the user equipment 123-127 sends signals to the Node B 110, 111, 114 is called an uplink. The communication link through which Node B 110, 111, 114 sends signals to a user equipment 123-127 is called a downlink.

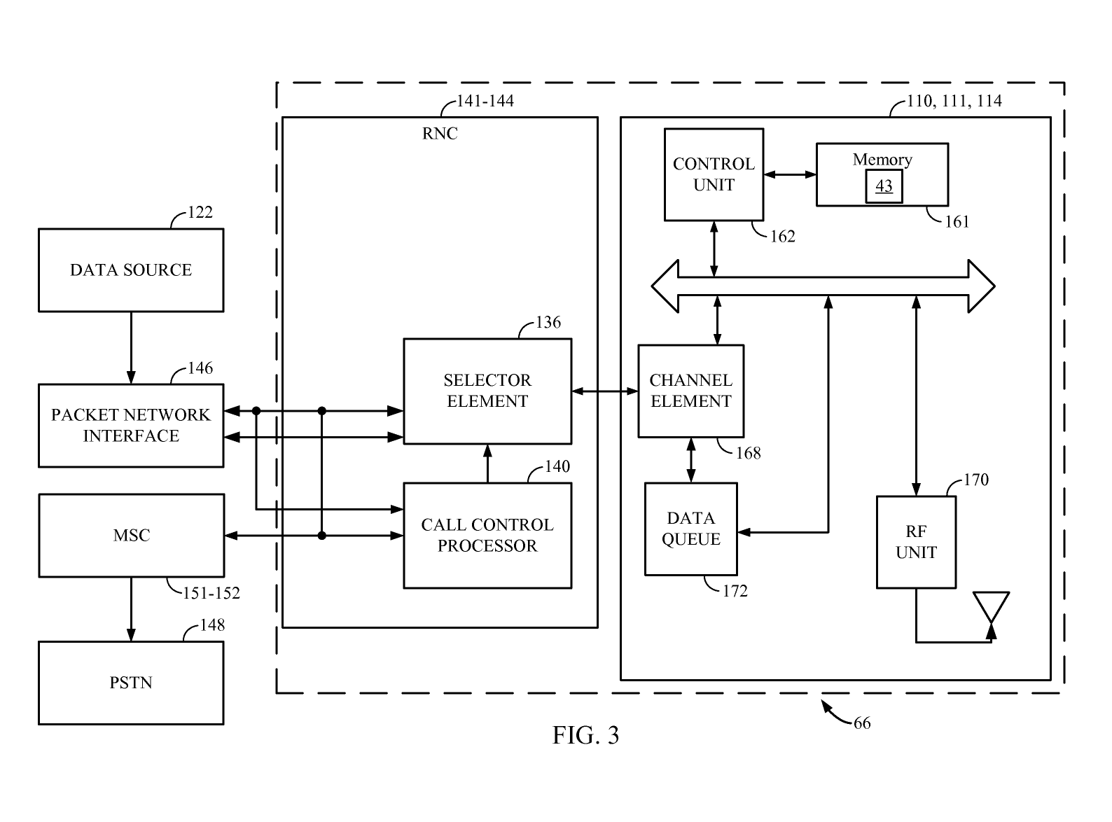

FIG. 3 is detailed herein below, wherein specifically, a Node B 110, 111, 114 and radio network controllers 141-144 interface with a packet network interface 146. (Note in FIG. 3, only one of the Node Bs 110, 111, 114 and only one of the RNCs 141-144 is shown for simplicity). The Node Bs 110, 111, 114 and radio network controller 141-144 may be part of a radio network server (RNS) 66, shown in FIG. 1 and in FIG. 3 as a dotted line surrounding one or more Node Bs 110, 111, 114 and the radio network controller 141-144. The associated quantity of data to be transmitted is retrieved from a data queue 172 in the Node Bs 110, 111, 114 and provided to the channel element 168 for transmission to the user equipment 123-127 associated with the data queue 172.

The radio network controller 141-144 interfaces with the Public Switched Telephone Network (PSTN) 148 through a mobile switching center 151, 152. Also, radio network controller 141-144 interfaces with Node Bs 110, 111, 114 in the communication network 100 (only one Node B 110, 111, 114 is shown in FIG. 2 for simplicity). In addition, the radio network controller 141-144 interfaces with a Packet Network Interface 146. The radio network controller 141-144 coordinates the communication between the user equipment 123-127 in the communication system and other users connected to packet network interface 146 and PSTN 148. The PSTN 148 interfaces with users through a standard telephone network (not shown in FIG. 3).

The radio network controller 141-144 contains many selector elements 136, although only one is shown in FIG. 3 for simplicity. Each selector element 136 is assigned to control communication between one or more Node Bs 110, 111, 114 and one remote station 123-127 (not shown). If the selector element 136 has not been assigned to a given user equipment 123-127, a call control processor 140 is informed of the desire to page the user equipment 123-127. The call control processor 140 then directs the Node Bs 110, 111, 114 to page the user equipment 123-127.

Data source 122 contains a quantity of data, which is to be transmitted to a given user equipment 123-127. The data source 122 provides the data to the packet network interface 146. The packet network interface 146 receives the data and routes the data to the selector element 136. The selector element 136 then transmits the data to the Node Bs 110, 111, 114 in communication with the target user equipment 123-127. In one example, each Node B 110, 111, 114 maintains a data queue 172 which stores the data to be transmitted to the user equipment 123-127.

For each data packet, a channel element 168 inserts the necessary control fields. In one example, the channel element 168 performs a cyclic redundancy check, CRC, encoding of the data packet and control fields and inserts a set of code tail bits. The data packet, control fields, CRC parity bits, and code tail bits comprise a formatted packet. The channel element 168 then encodes the formatted packet and interleaves (or reorders) the symbols within the encoded packet. The interleaved packet is covered with a Walsh code, and spread with the short PNI and PNQ codes. The spread data is provided to RF unit 170 which quadrature modulates, filters, and amplifies the signal. The downlink signal is transmitted over the air through an antenna to the downlink.

At the user equipment 123-127, the downlink signal is received by an antenna and routed to a receiver. The receiver filters, amplifies, quadrature demodulates, and quantizes the signal. The digitized signal is provided to a demodulator (DEMOD) where the digitized signal is despread with the short PNI and PNQ codes and decovered with the Walsh cover. The demodulated data is provided to a decoder which performs the inverse of the signal processing functions done at the Node Bs 110, 111, 114, specifically the de-interleaving, decoding, and CRC check functions. The decoded data is provided to a data sink.

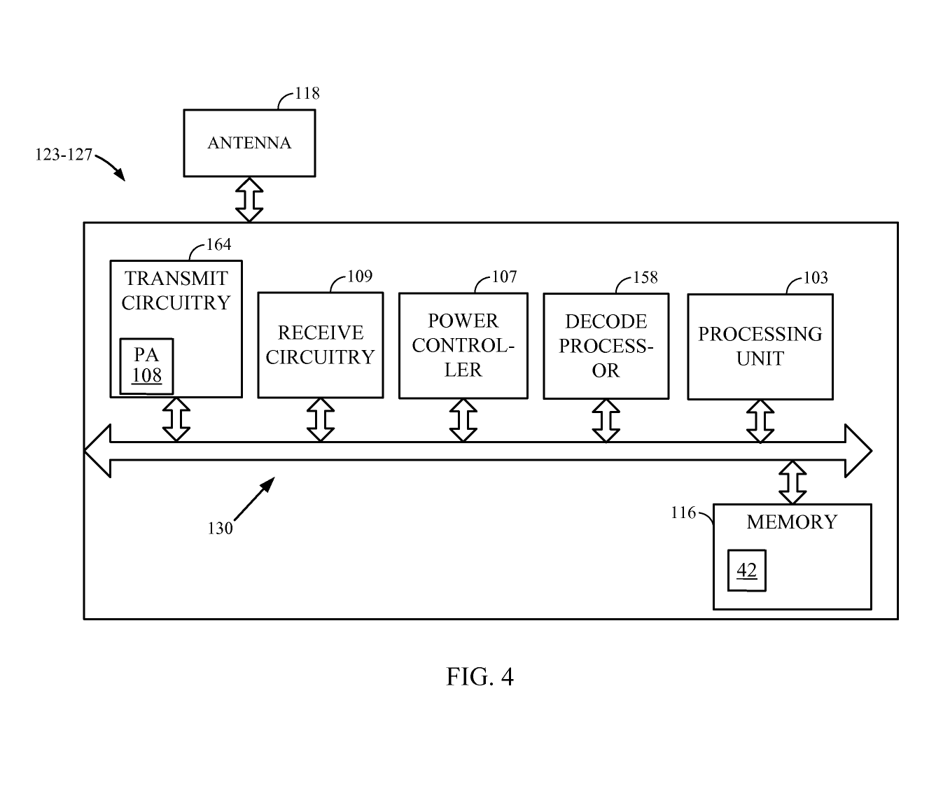

FIG. 4 illustrates an example of a user equipment (UE) 123-127 in which the UE 123-127 includes transmit circuitry 164 (including PA 108), receive circuitry 109, power controller 107, decode processor 158, a processing unit 103 for use in processing signals, and memory 116. The transmit circuitry 164 and the receive circuitry 109 may allow transmission and reception of data, such as audio communications, between the UE 123-127 and a remote location. The transmit circuitry 164 and receive circuitry 109 may be coupled to an antenna 118.

The processing unit 103 controls operation of the UE 123-127. The processing unit 103 may also be referred to as a CPU. Memory 116, which may include both read-only memory (ROM) and random access memory (RAM), provides instructions and data to the processing unit 103. A portion of the memory 116 may also include non-volatile random access memory (NVRAM).

The various components of the UE 123-127 are coupled together by a bus system 130 which may include a power bus, a control signal bus, and a status signal bus in addition to a data bus. For the sake of clarity, the various busses are illustrated in FIG. 4 as the bus system 130.

The steps of the methods discussed may also be stored as instructions in the form of software or firmware 43 located in memory 161 in the Node Bs 110, 111, 114, as shown in FIG. 3. These instructions may be executed by the control unit 162 of the Node Bs 110, 111, 114 in FIG. 3. Alternatively, or in conjunction, the steps of the methods discussed may be stored as instructions in the form of software or firmware 42 located in memory 116 in the UE 123-127. These instructions may be executed by the processing unit 103 of the UE 123-127 in FIG. 4.

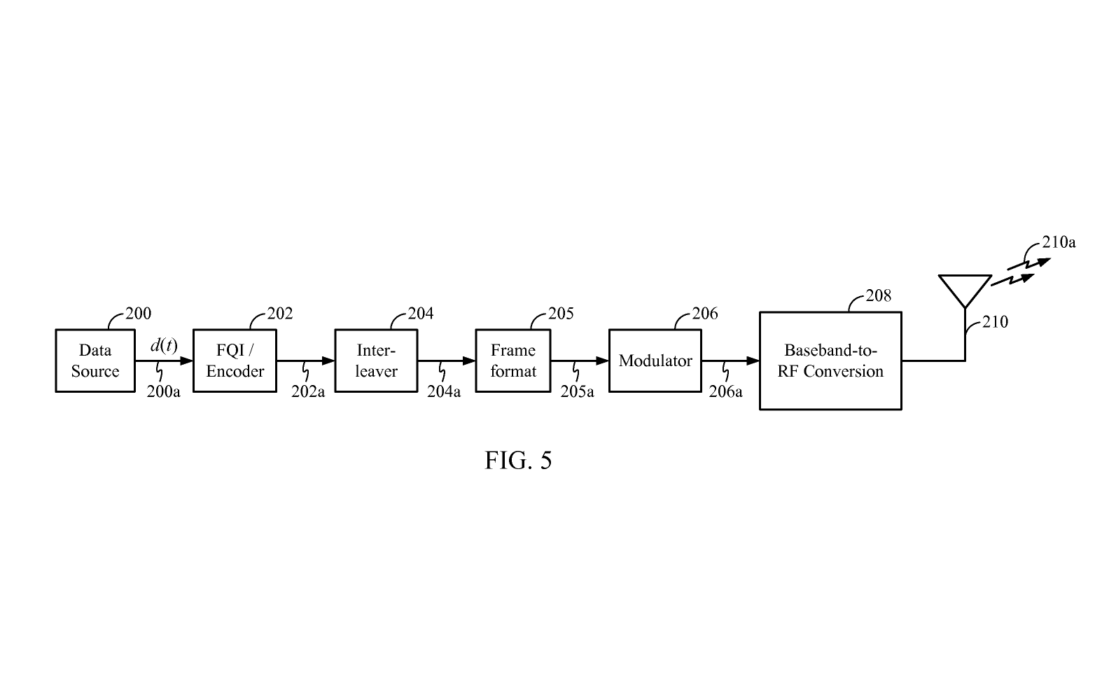

FIG. 5 illustrates an example of a transmitter structure and/or process, which may be implemented, e.g., at user equipment 123-127. The functions and components shown in FIG. 5 may be implemented by software, hardware, or a combination of software and hardware. Other functions may be added to FIG. 5 in addition to or instead of the functions shown in FIG. 5.

In FIG. 5, a data source 200 provides data d(t) or 200a to an FQI/encoder 202. The FQI/encoder 202 may append a frame quality indicator (FQI) such as a cyclic redundancy check (CRC) to the data d(t). The FQI/encoder 202 may further encode the data and FQI using one or more coding schemes to provide encoded symbols 202a. Each coding scheme may include one or more types of coding, e.g., convolutional coding, Turbo coding, block coding, repetition coding, other types of coding, or no coding at all. Other coding schemes may include automatic repeat request (ARQ), hybrid ARQ (H-ARQ), and incremental redundancy repeat techniques. Different types of data may be encoded with different coding schemes.

An interleaver 204 interleaves the encoded data symbols 202a in time to combat fading, and generates symbols 204a. The interleaved symbols of signal 204a may be mapped by a frame format block 205 to a pre-defined frame format to produce a frame 205a. In an example, a frame format may specify the frame as being composed of a plurality of sub-segments. Sub-segments may be any successive portions of a frame along a given dimension, e.g., time, frequency, code, or any other dimension. A frame may be composed of a fixed plurality of such sub-segments, each sub-segment containing a portion of the total number of symbols allocated to the frame. For example, according to the W-CDMA standard, a sub-segment may be defined as a slot. According to the cdma2000 standard, a sub-segment may be defined as a power control group (PCG). In one example, the interleaved symbols 204a are segmented into a plurality S of sub-segments making up a frame 205a.

A frame format may further specify the inclusion of, e.g., control symbols (not shown) along with the interleaved symbols 204a. Such control symbols may include, e.g., power control symbols, frame format information symbols, etc.

A modulator 206 modulates the frame 205a to generate modulated data 206a. Examples of modulation techniques include binary phase shift keying (BPSK) and quadrature phase shift keying (QPSK). The modulator 206 may also repeat a sequence of modulated data.

A baseband-to-radio-frequency (RF) conversion block 208 may convert the modulated signal 206a to RF signals for transmission via an antenna 210 as signal 210a over a wireless communication link to one or more Node B station receivers.

The Node B sets the quality target, e.g., the target Uplink Transmit Power Control Bit Error Rate (ULTPC BER) for the TPC group that contains the High Speed Downlink Shared Channel (HS-DSCH) serving cell. When the FDPCH is setup or reconfigured, the user equipment (UE) sets the Signal to Interference Ratio (SIR) Target (SIRT) depending on the target ULTPC BER. Inner Loop Power Control (ILPC) helps SIR Estimate (SIRE) to converge to SIRT by generating downlink TPC (DLTPC) bits for Node B to increase/decrease the transmit power. However, given the target BER, it is infeasible to find a universal SIRT for all possible propagation channels. For fading channels, the pre-determined SIRT may not guarantee UE to achieve the target ULTPC BER, even though SIRE converges to SIRT. Therefore, outer loop power control (OLPC) is used to adjust the SIRT adaptively.

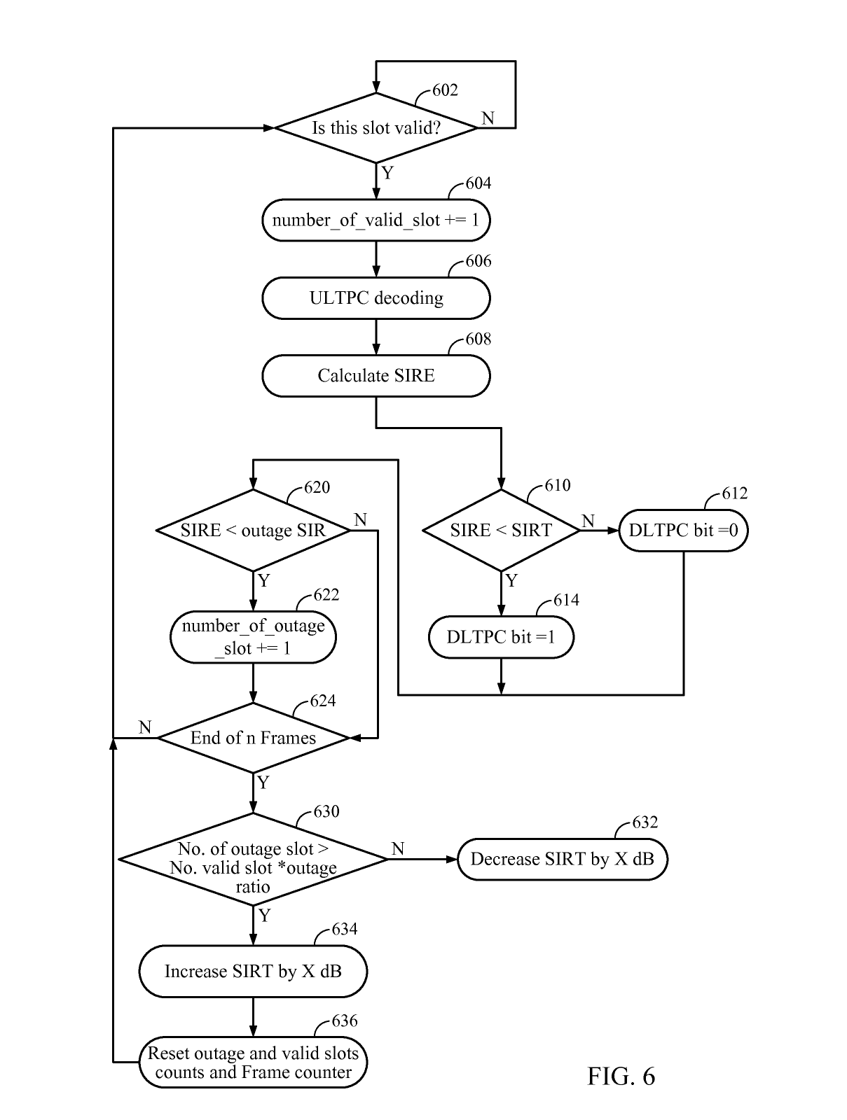

On the other hand, traditional downlink power control uses the CRC error and the block error rate (BLER) target to adjust the requested downlink power. However, since FDPCH has no CRC in the down link FDPCH and uses the TPC BER as the target performance, modification to the power control loop is necessary. An exemplary modification is describe in relation to FIG. 6 below, which may be implemented in software, firmware or combinations thereof on an exemplary UE 123-127, such as illustrated in FIG. 4.

The 3GPP standards specifies that the quality target for Fractional Dedicated Physical Channel (FDPCH) is the Uplink Transmit Power Control (ULTPC) command error rate target value for the FDPCH belonging to the TPC group containing the High Speed Downlink Shared Channel (HS-DSCH) serving cell, while the ULTPC demodulation is done per TPC group. Therefore, the SIR estimate (SIRE) is calculated based on TPC bits from all cells in the TPC group which contains the HS-DSCH serving cell. The SIR target (SIRT) is set when the FDPCH is setup or reconfigured. Inner Loop Power Control (ILPC) is used to have the SIRE track to the SIRT by generating Downlink Transmit Power Control (DLTPC) bits and sending these to the Node B.

For ILPC only, the SIRT is not changed. SIRT may be read from a lookup table for FDPCH for each ULTPC BER target can be derived from Additive White Gaussian Noise (AWGN) tests with only ILPC enabled. Different SIRTs can be tried and the SIRTs corresponding to the BER targets can be chosen. Since the initial SIR target is conventionally derived based on an AWGN channel model, it cannot guarantee to achieve the target BER under fading.

Because of variations over time and space in the signal paths between the different UEs and the base station, it is generally impractical to fix the transmit power for signals communicated between a UE and the base station. Various transmit power control methods and systems are known in the art, including open loop and feedback, or closed loop. Open loop transmit power control is known, therefore, further detailed description is omitted. In one conventional closed loop transmit power control, by the UE of a transmit power by the base station, the MT calculates or detects an estimated signal-to-interference ratio (SIRE) of the signal received from the base station, and compares the SIRE to a target SIRE (SIRT). Generally, the time interval over which the UE determines the SIRE is short, for example one slot of a signal having a multi-slotted frame format. The UE at a generally high rate, for example, after each one slot SIRE to SIRT comparison, generates and sends a transmit power control (TPC) message to the base station or stations transmitting the multi-slotted frame signal. The TPC message indicates whether the base station should increase or decrease the transmission power. Since the multi-slotted frame signal for which the UE is controlling the power is a downlink, this TPC message will be referenced as a “downlink TPC message.”

As described above, the time interval over which the UE determines the SIRE, and then generates and transmits a corresponding downlink TPC message, is short, for example a single slot duration. Also, the UE can detect the SIRE, and generate the downlink TPC message, without having to decode the received signal. The downlink TPC message is therefore based on the “raw” signal, inside of the encoding. This closed loop power control by the UE is therefore referenced in the art as “inner loop” closed loop transmit power control, or “inner loop TPC.” As also known to such persons, because of the short duration (e.g., one slot) SIRE interval, and corresponding immediate downlink TPC message, inner loop TPC provides a fast response control of the base station transmitter.

In one aspect a Digital Signal Processor (DSP) or other general-purpose processor can be deployed for delivering data for transmission to variable power transmitter, as well as for controlling various other communication functions within base station. The function of message decoder, as well as various parts of receiver may be carried out in a general-purpose processor, special purpose hardware, or a combination of both. Memory or other media may be attached to the processor for carrying out software, firmware, or other instructions to perform the various tasks described herein.

In inner loop TPC, the UE compares the SIRE of the received signal to a SIRT. In inner loop TPC, for control of the transmit power of a signal carried in a transport channel of the downlink signal and encoded to have, when decoded, a discernible Bit Error Rate (BER), the SIRT is calculated or mapped to based on a given desired (or mandated) maximum of that BER (MAX_BER). Factors that determine the MAX_BER can, for example, include the kind or the format of information carried by the signal, i.e., the signal content (e.g., MP4 or simple voice), and desired quality-of-signal (QoS) parameters. These various factors that can determine MAX_BER for signals received by the UE are known in the art and, therefore, further detailed description is omitted. Assuming an appropriately encoded signal is carried in a transport channel of a downlink from a base station to a UE, where “appropriately encoded” means that a BER can be determined, known techniques can be used to determine the minimum SIRT that will produce (with acceptable probability) a BER less than the given MAX_BER.

Closed-loop TPC methods exploit the above-described relation of the BER or block error rate detected by the UE to SIR, in another closed loop, to update the SIRT used by the inner loop TPC. Since this additional closed-loop TPC method of updating the SIRT used in the inner loop TPC uses the BER information, which is after, or outside of the decoding of the received signal, it is generally referred to as “outer loop closed loop TPC,” or “outer loop TPC.”

Outer loop TPC includes the UE decoding the received signal from the base station, generating a measured BER and comparing the measured BER to the MAX_BER. The generating or measuring of the BER, and comparing to the MAX_BER is performed at significantly lower rate. i.e., over a significantly longer duration than used to measure the SIRE. If the measured BER is higher than the MAX_BER the transmit power is too low and the UE increases the SIRT. The TPC messages, as a result, converge the signal received at the UE to a higher power. If, on the other hand, the measured BER is lower than the MAX_BER this indicates the base station is using an unnecessarily high transmit power. The UE therefore decreases the SIRT. The TPC messages, as a result, converge the signal received at the UE to a lower power.

It can be understood that the inner-loop generation of TPC messages and outer loop control of the SIRT used by the inner loop, by exploiting in a particular manner the detectable BER of the signal received by the UE, causes the SIRT to converge, for each transport channel, to a value at which the detected SIRE being equal to the SIRT establishes the base station transmit power at the minimum required to meet the given MAX_BER. It can be further be appreciated that the combination of inner loop and output loop TPC is based on the detected BER of the received signal.

3GPP includes a High Speed Downlink Packet Access (HSDPA). As specified by 3GPP, in HSDPA each user (e.g., each UE) is allocated a dedicated physical channel (DPCH), uplink and downlink, to exchange higher layer signaling information with the base station and a core network connected to the base stations. Since each user is allocated a DPCH, a high population of users in a cell can reduce available channelization codes. 3GGP therefore provides a fractional dedicated physical channel (F-DPCH). The F-DPCH is special downlink channel carrying only TPC commands generated at layer 1. Multiple HSDPA users share the same F-DPCH channelization code by a time-multiplexing of their respective TPC commands generated at layer 1. For example, according to 3GPP ten HSDPA users can share a single channelization code, each having 256 chips of the 2560 chips provided in that single channel. The 256 chip “slot” allocated to each HSDP user carries only two bits, generally as a single BPSK symbol. F-DPCH does not carry any transport channels and, therefore, cannot carry coded signals from which BER can be derived. Therefore, F-DPCH demonstrates one example in which conventional outer loop power control at the UE is inherently not capable of adjusting the SIRT used by its inner loop.

In an example system according to one exemplary embodiment, a UE can perform a closed loop power control of a base station transmitted F-DPCH downlink, with an outer loop control of the inner loop threshold, regardless of the slot allocated to that user.

In accordance with one exemplary embodiment an F-DPCH signal is received at the UE from a transmitter in one of the base stations. It will be assumed at a time slot within a given channelization code of the F-DPCH is allocated to UE. The allocated time slot can, but does not always, carry a given information symbol, for example an uplink TPC bit. Upon the UE receiving each slot it can, according to one or more exemplary embodiments, detect the presence or absence of the uplink TPC bit. The detection can be according to a given criterion that can be determined in the decoding of the slot. According to one or more exemplary embodiments, slots detected as carrying the uplink TPC bit are designated as valid slots. Slots not detected as carrying the uplink TPC bit are designated as not valid slots.

According to one exemplary embodiment, a signal quality estimation is performed on slots designated as valid (i.e., in this example, slots carrying an uplink TPC bit). In an aspect, the signal quality estimation can be an Estimated Signal-to-Interference Ratio (SIRE). In an inner loop aspect, the SIRE can be compared to a given target signal-to-interference ratio (SIRT). Further to this inner loop aspect, if the comparison shows the SIRE less than the SIRT a TPC increase downlink power signal or message. The TPC increase downlink power message can be transmitted from the UE to the base station, for example, according to conventional inner loop control techniques. Such techniques are known, therefore, further detailed description is omitted. In a related aspect, if the comparison shows the SIRE greater than the SIRT a TPC decrease downlink power signal or message can be sent to the base station.

According to one exemplary embodiment, an outage-based outer loop aspect adjusts the SIRT ratio accumulating, over an outer loop duration spanning a plurality of the slots, a total valid slot count and a total outage slot count. The total valid slot count is the number of slots over the outer loop duration detected as carrying TPC uplink bits. The total outage slot count is the number of slots that, although having uplink TPC bits, have an SIRE lower than the SIRT. In an aspect, an outage is calculated based on a ratio of the total outage count to the total valid slot count. In a further aspect, the SIRT can be updated based on a comparison of the calculated outage to a given outage.

In one aspect, updating the SIRT can include increasing the SIRT if the calculated outage exceeds the given target outage. In another aspect, updating the SIRT can include decreasing the SIRT if the calculated outage does not exceed the given target outage.

Referring to FIG. 6, to address this condition, which is mainly caused by channel variation, aspects of the disclosure use outage based Outer Loop Power Control (OLPC) for FDPCH. In addition to SIRT, the SIR outage threshold can also be determined based on the target ULTPC BER. Then, the SIR outage threshold can be compared with the SIRE calculated based on the ULTPC symbols in each slot, in a similar manner as the DLTPC is generated. For example, at 602, it is determined if a slot is valid (e.g., the slot contains Transmit Power Control (TPC) information). Also, the number of slots with a valid TPC is counted, at 604, for each frame due to compressed mode or Discontinuous Transmission (DTX). In 606, the ULTPC symbols in each slot are decoded. An SIRE can be calculated based on the ULTPC symbols in each slot, in 608.

The inner loop power control functions can be performed to provide downlink power control information to an associated Node B. For example, DLTPC information can be provided by setting a DLTPC bit to 0, in 612, if the SIRE is less than the SIRT in 610, and setting the DLTPC bit to 1, in 614, if the SIRE is greater than or equal to the SIRT, in 610.

The inner loop power control functions can be performed to provide downlink power control information to an associated Node B. For example, DLTPC information can be provided by setting a DLTPC bit to 0, in 612, if the SIRE is less than the SIRT in 610, and setting the DLTPC bit to 1, in 614, if the SIRE is greater than or equal to the SIRT, in 610.

Additionally, an outer loop power control function can be performed, which as noted above, improves the performance of the power control. For example, referring back to FIG. 6, for each frame, the number of outage slots (i.e., slots with SIRE less than SIR outage threshold, in 620). These outage slots can be counted, in 622. The process can continue for n frames, in 624. It will be appreciated that although the frame counting function is not expressly illustrated it can be implemented in many ways as will be appreciated (e.g., an outer loop triggered by end of frame detection, etc.). The operations for evaluating the slots within a given frame are illustrated in FIG. 6. However, regardless of how n and the end of n frames is tracked, once it is reached, for every n frames (e.g., n=5, 10, 20 or any integer number of frames), a comparison of the total number of outage slots to the outage ratio times the total number of slots with valid TPC can be determined, in 630.

If the actual outage ratio is greater than a preset target outage ratio (e.g., in the range of 6%-20% of the valid slots), as determined in 630, which means the channel condition is bad, the SIRT can be increased by X dB, in 634. On the other hand, if the outage ratio is less than or equal to the preset target outage ratio, SIRT is decreased by X dB, in 632, since the channel condition is good. The step size can be adjusted within a range of values (e.g., X<1 dB). For example, in one aspect X can be 0.2 dB to keep the power change reasonable. Accordingly, for this example, if the outage ratio is larger than the target outage ratio, SIRT can be multiplied by 1.0471. On the other hand, the SIR target can be multiplied by 0.9550 if the outage ratio is lower than the target outage point.

Additionally, it will be appreciated that a windowing or threshold function may be provided in relationship to the adjustment of the Target Signal Quality (SIRT) based on the comparison in 630. For example, there could be a first outage ratio for an increase and a second outage ratio for a decrease, and any comparison that fell between those ratios would result in no change in the SIRT.

Finally, in 636, the number outage slots and the number of valid slots are reset along with the frame counter (which is not explicitly illustrated) and the process can return to 602 for the next series of n frames. As will be appreciated there can be a counter for n to count the number of frames, where the counter is incremented by one every time the loop encounters a new frame or an outer loop for frame counting may be implemented.

Note that, for FDPCH Outer Loop Power Control (OLPC), the outage threshold may not change and can be determined by the target ULTPC BER. However, as discussed above, the outage OLPC can adjust the SIRT to achieve the target ULTPC BER. Simulation results show that this greatly helps to achieve the target BER in case of fading channels.

One simulated example of the performance improvement is shown in Table 1 for case 4 channel (see, 3GPP TS 25.101, 2010) with −1 dB Geometry. With the inner loop power control (ILPC) only, the converged BER is much higher than the target BER. This can lead to test failure on targets. However, with outage-based OLPC, the BER is pulled down to the desirable range. Furthermore, there is enough margin to pass various performance tests. Therefore, through dynamically changing the SIRT, OLPC helps the UE to converge to the ULTPC BER target.

TABLE 1
Performance improvement of OLPC for Case 4 Geometry −1 dB

| | ILPC | | OLPC | |
|---|---|---|---|---|
| Target BER | BER | Converged EcIo | BER | Converged EcIo |
| 1% | 1.39% | −12.988 dB | 0.84% | −12.21 dB |
| 5% | 6.4457% | −15.8811 dB | 3.68% | −14.92 dB |
| 10% | 12.0211% | −18.2504 dB | 9.54% | −17.38 dB |

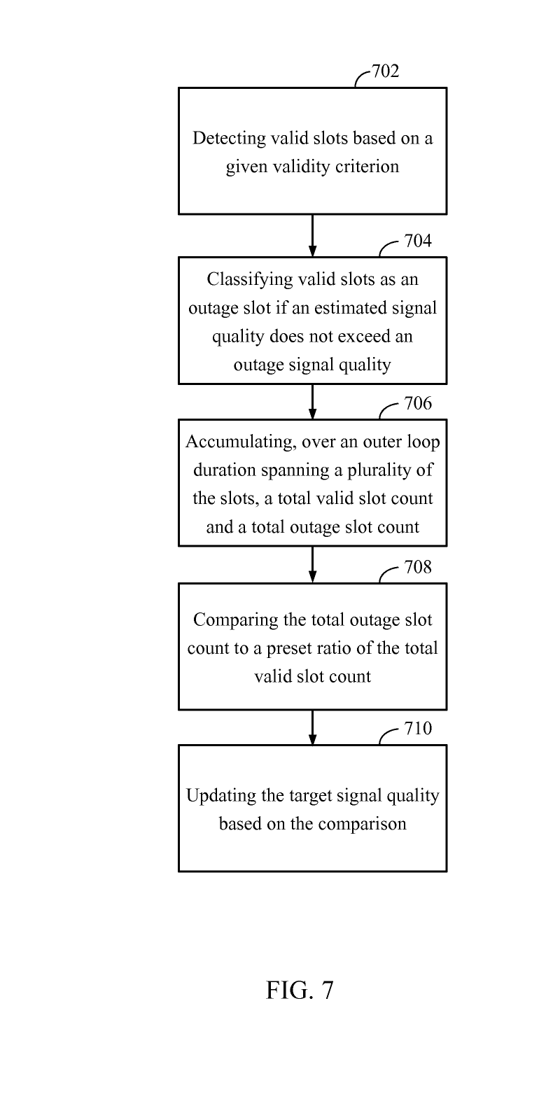

In view of the foregoing, it will be appreciated that the various steps, sequences of actions and/or algorithms disclosed can constitute methods according to the various embodiments and that not all actions need to be performed as detailed herein. For example, referring to FIG. 7, a simplified flowchart of a method for closed loop power control is illustrated. In 702, valid slots are detected based on a given validity criterion (e.g., slots detected as carrying the uplink TPC). In 704, the valid slots are classified as an outage slot if an estimated signal quality does not exceed an outage signal quality. In 706, a total valid slot count and a total outage slot count are accumulated over an outer loop duration spanning a plurality of the slots. In 708, the total outage slot count is compared to a preset ratio of the total valid slot count. Then, in 710, the target signal quality is updated based on the comparison (e.g., if total outage slot count is greater than the preset ratio, then the target signal quality (e.g., SIRT) is increased, if not it is decreased). As discussed in the foregoing, the new target signal quality can then be used in the Inner Loop Power control (ILPC).

Additionally, in view of the foregoing, it will be appreciated that various actions described herein can be performed by specific circuits (e.g., application specific integrated circuits (ASICs)), by program instructions stored in memory (e.g., 42 of 116 of FIG. 4) being executed by one or more processors (e.g., 103, 158 of FIG. 4), may be logic within specific elements such as power controller 107 or by various combinations generally referred to as “logic configured to”. Accordingly embodiments can include various logic configured to perform the designated functions disclosure herein.

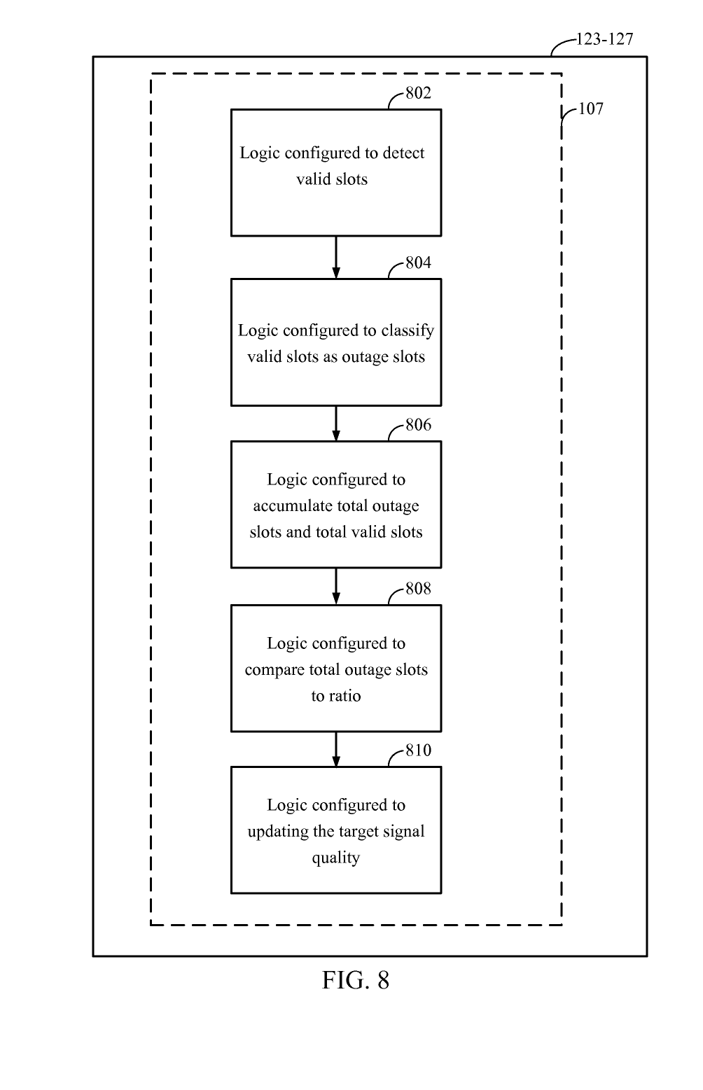

For example, referring to FIG. 8, a UE (e.g., any of UEs 123-127 or any other UE) can contain the various logic elements or modules configured to perform the various functions disclosed herein. For example, logic element or module 802, can include logic configured to detect valid slots based on a given validity criterion (e.g., slots detected as carrying the uplink TPC information). Logic element or module 804 can include logic configured to classify the valid slots as an outage slot if an estimated signal quality does not exceed an outage signal quality. Logic element or module 806 can include logic configured to accumulate a total valid slot count and a total outage slot count over an outer loop duration spanning a plurality of the slots. Logic element or module 808 can include logic configured to compare the total outage slot count to a preset ratio of the total valid slot count. Logic element or module 810 can include logic configured to update the target signal quality based on the comparison (e.g., if total outage slot count is greater than the preset ratio, then the target signal quality (e.g., SIRT) is increased, if not it is decreased). The logic elements or modules can be included in or functionally coordinated with power controller 107, in one aspect. However, the arrangements illustrated are merely provided as examples and the functionality does not have to be contained within any specific element. Likewise, it will be appreciated that the functionality may also be further divided and or integrated. For example, modules 806 and 808 could be combined into a functional unit that accumulates and compares. Therefore, the various embodiments are not limited to any specific arrangement and/or realization of the various elements and systems detailed herein.

Information and signals discussed in the foregoing may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the disclosure and claims.

Various illustrative logical blocks, modules, and circuits described in connection with the examples disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium. An exemplary storage medium is coupled to the processor such that the processor can read information from, and write information to, the storage medium. In the alternative, the storage medium may be integral to the processor. The processor and the storage medium may reside in an ASIC. The ASIC may reside in a UE. In the alternative, the processor and the storage medium may reside as discrete components in a UE. Accordingly, it will be appreciated that various embodiments can include any means for performing the functionality disclosed herein.

In one or more exemplary examples, the functions described may be implemented in hardware, software, firmware, or any combination thereof. If implemented in software, the functions may be stored on or transmitted over as one or more instructions or code on a computer-readable medium. Computer-readable media includes computer storage media. A computer storage media or computer storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave, the coupling of the computer storage medium does not limit the definition of computer storage medium, so remote storage media also is included in computer storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media. Additionally, as used herein the term “non-transient” does not exclude any physical storage medium or transitory states of physical storage medium, but rather excludes only the interpretation that the medium can be construed as a transitory propagating signal.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated. Thus, the claims are not intended to be limited to the examples shown herein but is to be accorded the widest scope consistent with the principles and novel features disclosed herein.

Therefore, the disclosure is not to be limited except in accordance with the following claims.

What is claimed is:

1. A method for closed loop power control of a signal having slots, the method comprising:
detecting valid slots based on a given validity criterion;
classifying the valid slots as outage slots if an estimated signal quality does not exceed an outage signal quality;
accumulating, over an outer loop duration spanning a plurality of the slots, a total valid slot count and a total outage slot count;
comparing the total outage slot count to a preset ratio of the total valid slot count; and
updating a target signal quality based on the comparison.

2. The method of claim 1, wherein the updating includes:
increasing the target signal quality if the total outage slot count is greater than the preset ratio of the total valid slot count.

3. The method of claim 2, wherein the target signal quality is a signal to interference ratio target (SIRT) that is increased by a fixed amount.

4. The method of claim 3, wherein the fixed amount is less than 1 dB.

5. The method of claim 3, wherein the fixed amount is less than 0.2 dB.

6. The method of claim 1, wherein the updating includes:
decreasing the target signal quality if the total outage slot count is less than the preset ratio of the total valid slot count.

7. The method of claim 6, wherein the target signal quality is a signal to interference ratio target (SIRT) that is increased by a fixed amount.

8. The method of claim 7, wherein the fixed amount is less than 1 dB.

9. The method of claim 7, wherein the fixed amount is less than 0.2 dB.

10. The method of claim 1, wherein the signal comprises frames having multiple slots, and wherein the outer loop duration spans N frames, N being an integer.

11. The method of claim 10, further comprising:
resetting the total valid slot count and the total outage slot count.

12. The method of claim 1, wherein the given validity criterion is based on the valid slots having uplink TPC (ULTPC) information.

13. The method of claim 12, wherein the signal is an F-DPCH signal.

14. The method of claim 13, further comprising:
decoding the (ULTPC) information in each valid slot.

15. The method of claim 14, further comprising:
estimating a signal quality of the valid slots to generate an estimated signal-to-interference ratio (SIRE), and wherein the target signal quality represents a target signal-to-interference ratio (SIRT).

16. The method of claim 15, further comprising:
performing an inner loop power control based on a comparison of the SIRE to the SIRT.

17. The method of claim 16, wherein the inner loop power control comprises:
providing downlink transmit power control (DLTPC) feedback to an associated Node B.

18. The method of claim 17, wherein the DLTPC feedback is provided by setting a DLTPC bit to 0 if the SIRE is less than the SIRT and setting the DLTPC bit to 1 if the SIRE is not less than the SIRT.

19. The method of claim 1, wherein the preset ratio is in a range of 6 to 20 percent.

20. The method of claim 1, further comprising:
performing an inner loop power control based on a comparison of an estimated signal-to-interference ratio and the target signal quality.

21. A user equipment (UE) configured to perform closed loop power control of a signal having slots, the UE comprising:
logic configured to detect valid slots based on a given validity criterion;
logic configured to classify the valid slots as outage slots if an estimated signal quality does not exceed an outage signal quality;
logic configured to accumulate, over an outer loop duration spanning a plurality of the slots, a total valid slot count and a total outage slot count;
logic configured to compare the total outage slot count to a preset ratio of the total valid slot count; and
logic configured to update a target signal quality based on the comparison.

22. The user equipment of claim 21, wherein the updating includes:
logic configured to increase the target signal quality if the total outage slot count is greater than the preset ratio of the total valid slot count.

23. The user equipment of claim 21, wherein the logic configured to update includes:
logic configured to decrease the target signal quality if the total outage slot count is less than the preset ratio of the total valid slot count.

24. The user equipment of claim 21, wherein the signal comprises frames having multiple slots, and wherein the outer loop duration spans N frames, N being an integer.

25. The user equipment of claim 24, further comprising:
logic configured to reset the total valid slot count and the total outage slot count.

26. The user equipment of claim 21, wherein the given validity criterion is based on the valid slots having uplink TPC (ULTPC) information.

27. The user equipment of claim 26, further comprising:
logic configured to decode the (ULTPC) information in each valid slot.

28. The user equipment of claim 27, further comprising:
logic configured to estimate a signal quality of the valid slots to generate an estimated signal-to-interference ratio (SIRE), and wherein the target signal quality represents a target signal-to-interference ratio (SIRT); and
logic configured to performing an inner loop power control based on a comparison of the SIRE to the SIRT.

29. The user equipment of claim 21, wherein the preset ratio is in a range of 6 to 20 percent.

30. The user equipment of claim 21, further comprising:
logic configured to perform an inner loop power control based on a comparison of an estimated signal-to-interference ratio (SIRE) and the target signal quality.

31. An apparatus for closed loop power control of a signal having slots, the apparatus comprising:
means for detecting valid slots based on a given validity criterion;
means for classifying the valid slots as outage slots if an estimated signal quality does not exceed an outage signal quality;
means for accumulating, over an outer loop duration spanning a plurality of the slots, a total valid slot count and a total outage slot count;
means for comparing the total outage slot count to a preset ratio of the total valid slot count; and
means for updating a target signal quality based on the comparison.

32. The apparatus of claim 31, wherein the means for updating includes:
means for increasing the target signal quality if the total outage slot count is greater than the preset ratio of the total valid slot count.

33. The apparatus of claim 31, wherein the means for updating includes:
means for decreasing the target signal quality if the total outage slot count is less than the preset ratio of the total valid slot count.

34. The apparatus of claim 31, further comprising:
means for decoding uplink TPC (ULTPC) information in each valid slot.
means for estimating a signal quality of the valid slots to generate an estimated signal-to-interference ratio (SIRE), and wherein the target signal quality represents a target signal-to-interference ratio (SIRT).
means for performing an inner loop power control based on a comparison of the SIRE to the SIRT.

35. The apparatus of claim 31, further comprising:
means for performing an inner loop power control based on a comparison of an estimated signal-to-interference ratio and the target signal quality.

36. A non-transitory computer-readable storage medium containing instructions stored thereon, which, when executed by at least one processor causes the at least one processor to perform power control, the instructions comprising:
at least one instruction to detect valid slots based on a given validity criterion;
at least one instruction to classify valid slots as outage slots if an estimated signal quality does not exceed an outage signal quality;
at least one instruction to accumulate, over an outer loop duration spanning a plurality of the slots, a total valid slot count and a total outage slot count;
at least one instruction to compare the total outage slot count to a preset ratio of the total valid slot count; and
at least one instruction to update a target signal quality based on the comparison.

37. The non-transitory computer-readable storage medium of claim 36, wherein the at least one instruction to update includes:
at least one instruction to increase the target signal quality if the total outage slot count is greater than the preset ratio of the total valid slot count.

38. The non-transitory computer-readable storage medium of claim 36, wherein the at least one instruction to update includes:
at least one instruction to decrease the target signal quality if the total outage slot count is less than the preset ratio of the total valid slot count.

39. The non-transitory computer-readable storage medium of claim 36, further comprising:
at least one instruction to decode uplink TPC (ULTPC) information in each valid slot.
at least one instruction to estimate a signal quality of the valid slots to generate an estimated signal-to-interference ratio (SIRE), and wherein the target signal quality represents a target signal-to-interference ratio (SIRT); and
at least one instruction to perform an inner loop power control based on a comparison of the SIRE to the SIRT.

40. The non-transitory computer-readable storage medium of claim 36, further comprising:
at least one instruction to perform an inner loop power control based on a comparison of an estimated signal-to-interference ratio (SIRE) and the target signal quality.
